(19) United States
(12) Patent Application Publication
(10) Pub. No.: US 2008/0143813 A1
(43) Pub. Date: Jun. 19, 2008

(54) IMAGE FORMING APPARATUS AND METHOD FOR SETTING UP LASER SCANNING UNIT

(75) Inventor: Hyeong Ill LEE, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/870,659

(22) Filed: Oct. 11, 2007

(30) Foreign Application Priority Data
Dec. 18, 2006 (KR) 2006-129454

(51) Int. Cl. B41J 2/435

(52) U.S. Cl. 347/248

(57) ABSTRACT

An image forming apparatus to set up a laser scanning unit includes a laser scanning unit to irradiate light, a photosensitive member on which an electrostatic latent image is formed by receiving the light irradiated from the laser scanning unit, a supply unit to apply a developing agent to the electrostatic latent image formed on the photosensitive member to form a visible image, and a transfer unit to transfer the visible image formed on the photosensitive member to a printing medium, wherein a time period in which the photosensitive member is rotated from an exposure point of the photosensitive member at which the light is incident to a transfer point of the photosensitive member at which the visible image is transferred, is based on a variation time period of a rotational speed of the photosensitive member.

### CROSS-REFERENCE TO RELATED APPLICATION

This application claims all benefits accruing under 35 U.S.C. §119 from Korean Patent Application No. 2006-129454, filed on Dec. 18, 2006, in the Korean Intellectual Property Office, the disclosure of which is incorporated herein by reference.

### BACKGROUND OF THE INVENTION

1. Field of the Invention

Aspects of the present invention relate to an image forming apparatus, and more particularly to an image forming apparatus and a method for setting up a laser scanning unit which is capable of irradiating light onto a photosensitive member so as to form an electrostatic latent image, applying a developing agent to the electrostatic latent image so as to form a visible image, and then transferring the visible image onto a printing medium.

2. Description of the Related Art

In general, image forming apparatuses are classified as mono-image forming apparatuses which form black-and-white images and color image forming apparatuses which form color images. Examples of such image forming apparatuses include laser printers, photocopiers, facsimile machines and multi-functional products. Recently, image forming apparatuses employing a variety of image forming schemes have been developed and utilized in order to form black-and-white images and color images.

Among these image forming schemes, an image forming apparatus employing an electro-photographic method irradiates light onto a photosensitive member (i.e., photosensitive drum) charged with a predetermined potential, forms an electrostatic latent image on an outer circumferential surface of the photosensitive member, applies a toner (also referred to as a developing agent) to the electrostatic latent image to develop the electrostatic latent image as a visible image, transfers the visible image onto a printing medium, and then fixes the visible image to the printing medium, thereby printing images. Typically, a developing unit is detachably installed in a body of the image forming apparatus to develop such images.

Generally, such a developing unit includes a photosensitive member on which an electrostatic latent image is formed and a developing roller to apply toner to the outer circumferential surface of the photosensitive member. In addition, a toner cartridge is included therein to supply toner. When the toner is completely used up, a user needs to replace the depleted toner with new toner. The photosensitive member rotates by receiving a driving force from a motor, such as, for example, an electric motor, provided in the body of the image forming apparatus. To this end, couplings are provided between the motor and the photosensitive member. When the developing unit is installed in the body of the image forming apparatus, a driving coupling of the motor is coupled with a driven coupling of the photosensitive member such that the driving force of the motor is delivered to the photosensitive member.

A conventional image forming apparatus using the electro-photographic method is disclosed in U.S. Pat. No. 6,876,821 (filed on Dec. 09, 2002). The image forming apparatus disclosed in U.S. Pat. No. 6,876,821 is a color image forming apparatus having four developing units. Light irradiated from a laser scanning unit is transmitted to the developing units so that electrostatic latent images are formed, toners of yellow, magenta, cyan, and black colors are applied to the electrostatic latent images, and visible images corresponding to the colors are overlapped with each other on a printing medium, such as a sheet of paper, a transparency sheet, etc., thereby printing a color image.

However, in this conventional image forming apparatus, when each developing unit has been installed in the body, eccentricity may occur between the central axis of the driving coupling and the central axis of the driven coupling due to errors incurred when the image forming apparatus is manufactured or assembled. As a result of the eccentricity, the photosensitive members rotate at various speeds, which can be represented by specific waveforms, due to the deviation between the central axes. Thus, the eccentricity causes the rotational speed of each photosensitive member to be irregular instead of uniform. Accordingly, the visible images of the colors do not uniformly overlap with each other, and a color registration error occurs.

In order to solve this problem, a scheme of detecting the speed variation of the photosensitive members using various types of sensors to change the rotational speed of the motor has been suggested. However, such a scheme results in complicated control operations and increases the manufacturing costs due to the addition of extra components.

### SUMMARY OF THE INVENTION

Several aspects and example embodiments provide an image forming apparatus and a method for setting up a laser scanning unit, which are capable of reducing color registration errors caused by deviations between the central axes of a driving coupling and a driven coupling of a photosensitive member using a simple technique which does not require adding extra components.

Additional aspects and/or advantages of the invention will be set forth in part in the description which follows and, in part, will be obvious from the description, or may be learned by practice of the invention.

In accordance with an example embodiment of the present invention, an image forming apparatus is provided with a laser scanning unit to irradiate light, a photosensitive member on which an electrostatic latent image is formed by receiving the light irradiated from the laser scanning unit, a supply unit to apply a developing agent to the electrostatic latent image formed on the photosensitive member to form a visible image, and a transfer unit to transfer the visible image formed on the photosensitive member to a printing medium, wherein a time period in which the photosensitive member is rotated from an exposure point of the photosensitive member at which the light is incident to a transfer point of the photosensitive member at which the visible image is transferred is based on a variation time period of a rotational speed of the photosensitive member.

According to an aspect of the present invention, the time period in which the photosensitive member is rotated from the exposure point to the transfer point is equal to the variation time period.

According to another aspect of the present invention, multiple of the photosensitive members are provided, and time periods in which the multiple photosensitive members are moved from exposure points to transfer points are integer multiples relative to respective variation time periods.

In accordance with another example embodiment of the present invention an image forming apparatus is provided with a laser scanning unit to irradiate light, a photosensitive member on which an electrostatic latent image is formed by receiving the light irradiated from the laser scanning unit, a supply unit to apply a developing agent to the electrostatic latent image formed on the photosensitive member to form a visible image, a transfer unit to transfer the visible image formed on the photosensitive member to a printing medium, a driven coupling coupled with the photosensitive member and having a plurality of driven coupling protrusions arranged at a predetermined angle from each other relative to a circumference of the driven coupling, and a driving coupling engageable with the driven coupling in order to rotate the driven coupling, and having a plurality of neighboring driving coupling recesses corresponding to the driven coupling protrusions, wherein an angle between an exposure point of the photosensitive member at which the light is incident and a transfer point of the photosensitive member at which the visible image is transferred is based on the predetermined angle between the neighboring driven coupling protrusions.

According to an aspect of the present invention, the angle between the exposure point and the transfer point is equal to the predetermined angle between the neighboring driven coupling protrusions.

According to another aspect of the present invention, multiple of the photosensitive members, the driven coupling, and the driving coupling are provided, and angles between exposure points and transfer points of each photosensitive member are integer multiples relative to angles between neighboring coupling protrusions among the protrusions of each driven coupling connected to the respective photosensitive medium.

In accordance with yet another example embodiment of the present invention, an image forming apparatus is provided with a laser scanning unit to irradiate light, a photosensitive member on which an electrostatic latent image is formed by receiving the light irradiated from the laser scanning unit, a supply unit to apply a developing agent to the electrostatic latent image formed on the photosensitive member to form a visible image, a transfer unit to transfer the visible image formed on the photosensitive member to a printing medium, a driven coupling coupled with the photosensitive member and having a plurality of neighboring driven coupling recesses arranged at a predetermined angle from each other relative to a circumference of the driven coupling, and a driving coupling engageable with the driven coupling in order to rotate the driven coupling, and having a plurality of driving coupling protrusions corresponding to the driven coupling recesses, wherein an angle between an exposure point of the photosensitive member at which the light is incident and a transfer point of the photosensitive member at which the visible image is transferred is based on the predetermined angle of the driven coupling recesses.

According to an aspect of the present invention, the angle between the exposure point and the transfer point is equal to the predetermined angle between the neighboring coupling recesses.

According to another aspect of the present invention, multiple of the photosensitive member, the driven coupling, and the driving coupling are provided, and angles between exposure points and transfer points of the photosensitive members are integer multiples relative to angles between neighboring coupling recesses among coupling recesses of driven couplings coupled with the respective photosensitive member.

In accordance with yet another example embodiment of the present invention a method to set up a laser scanning unit provides the operations of detecting a variation time period of a rotational speed of a photosensitive member on which an electrostatic latent image is formed by irradiated light and a visible image is formed by applying a developing agent to the electrostatic latent image, and setting a light irradiation position such that a time period in which the photosensitive member is moved from an exposure point of the photosensitive member at which the light is incident to a transfer point of the photosensitive member at which the visible image is transferred is an integer multiple relative to the variation time period.

According to an aspect of the present invention, the operation of setting the light irradiation point includes setting the time in which the photosensitive member is moved from the exposure point of the photosensitive member to the transfer point of the photosensitive member to be equal to the variation time period.

in accordance with yet another example embodiment of the present invention a method to set up a laser scanning unit provides the operations of detecting a variation time period of a rotational speed of a photosensitive member on which an electrostatic latent image is formed by irradiated light and a visible image is formed by applying a developing agent to the electrostatic latent image, and setting a light irradiation position such that an angle between an exposure point of the photosensitive member at which the irradiated light is incident and a transfer point of the photosensitive member at which the visible image is transferred is based on an angle between neighboring driven coupling protrusions or neighboring driven coupling recesses among a plurality of the driven coupling protrusions or a plurality of the driven coupling recesses formed on a driven coupling connected to a driving coupling which delivers a driving force to the driven coupling, the driven coupling protrusions or the driven coupling recesses formed on the driven coupling at a predetermined angle from each other, the driven coupling coupled with the photosensitive member.

According to an aspect of the present invention, the operation of setting the light irradiation position includes setting the light irradiation position such that the angle between the exposure point of the photosensitive member and the transfer point of the photosensitive member is the same as the angle between the neighboring driven coupling protrusions or the neighboring driven coupling recesses.

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 is a side sectional view schematically showing an image forming apparatus according to an example embodiment of the present invention;

FIG. 2 is an exploded perspective view schematically showing a driving coupling provided in the body of an image forming apparatus and a driven coupling of a photosensitive member according to an example embodiment of the present invention;

FIG. 3 is a front view showing the coupling structure between a driving coupling of the body of an image forming apparatus and a driven coupling of a photosensitive member according to an example embodiment of the present invention;

FIG. 4 is a graph showing the variation of a rotational speed of a photosensitive member of an image forming apparatus according to an example embodiment of the present invention;

FIG. 5 is a front view showing a driven coupling of a photosensitive member according to an example embodiment of the present invention;

FIG. 6 is a side view showing a photosensitive member and a transfer unit of an image forming apparatus according to an example embodiment of the present invention; and

FIG. 7 is a graph showing a variation of the rotational speed of a photosensitive member for the operation of an image forming apparatus according to an example embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

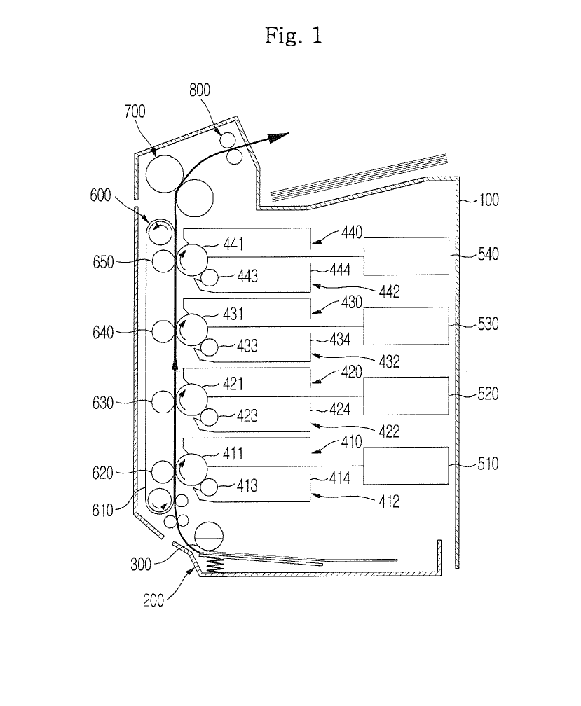

As shown in FIG. 1, the image forming apparatus 10 includes a body 100, a supplying unit 200 to supply printing media, such as sheets of paper, letterhead, recycled paper, transparency sheets, etc., a pick-up unit 300 to pick up individual sheets of the printing media one by one, a plurality of developing units 410, 420, 430, and 440 to form visible images which are transferred to the printing medium picked up by the pick-up unit 300, a plurality of laser scanning units 510, 520, 530, and 540 to irradiate light onto the developing units 410, 420, 430, and 440, a transfer unit 600 to transfer the visible images formed in the developing units 410, 420, 430, and 440 to the printing medium, a fixing unit 700 to fix the visible image transferred onto the printing medium, and a discharge unit 800 to discharge the printing medium to the outside of the body 10. It is understood that the image forming apparatus 10 may have other components in addition to those shown in FIG. 1 and described above, such as auxiliary printing paths, additional rollers, additional belts, additional print media trays, etc.

The developing units 410, 420, 430, and 440 respectively include photosensitive media 411, 421, 431, and 441 (e.g., photosensitive members or drums) to receive light in order to obtain electrostatic latent images and developing agent supplying units 412, 422, 432, and 442 to apply a developing agent (toner) to the photosensitive members 411, 421, 431 and 441. The developing agent supplying units 412, 422, 432 and 442, also known as supply units, respectively include developing rollers 413, 423, 433, and 443 and developing agent storage units 414, 424, 434, and 444. The transfer unit 600 includes a document transfer belt 610 to transfer each printing medium picked up by the pick up unit 300 and a plurality of transfer rollers 620, 630, 640, and 650 corresponding to the photosensitive members 411, 421, 431, and 441 installed in the inside of the document transfer belt 610. It is understood that the transfer unit 600 is not required to have the four transfer rollers 620, 630, 640, and 650, and instead may have more or less than four transfer rollers.

The developing units 410, 420, 430, and 440 are detachably installed in the body 100 in order to form visible images having colors formed from combinations of yellow, magenta, cyan, and black developing agents and apply the formed visible images to the transferred printing medium. When one the developing agents stored in the developing units 410, 420, 430, and 440 becomes depleted, a user replaces the depleted developing agent with a new developing agent. When the photosensitive members 411, 421, 431, and 441 and the developing rollers 413, 423, 433, and 443 of the developing units 410, 420, 430, and 440 are installed in the body 100, the photosensitive members 411, 421, 431, and 441 and the developing rollers 413, 423, 433, and 443 are rotated by a driving force transmitted from a driving source (not shown) disposed in the body 100. While the image forming apparatus 10 shown in FIG. 1 includes four developing units 410, 420, 430, and 440 corresponding to yellow, magenta, cyan, and black developing agents, other aspects of the present invention are not limited to having four developing units, and may instead have other numbers of developing units, such as, for example, three developing units corresponding to red, green, and blue developing agents.

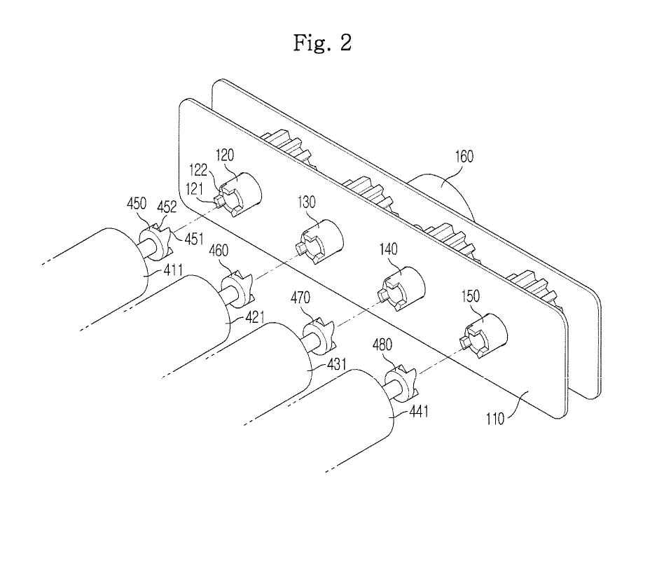

As shown in FIG. 2, the photosensitive members 411, 421, 431, and 441 include driven couplings 450, 460, 470, and 480. A frame 110, which supports the structural integrity of the body 100, includes driving couplings 120, 130, 140, and 150 coupled with the driven couplings 450, 460, 470, and 480. The driving couplings 120, 130, 140, and 150 are rotated by a driving force transmitted from a motor 160. According to an aspect of the present invention, the motor 160 is an electric motor. However, the motor 160 may be various other types as well.

The driven couplings 450, 460, 470, and 480 have the same structure as each other. In addition, the driving couplings 120, 130, 140, and 150 have the same structure as each other. Hereinafter, the structure and the operation of the driven coupling 450 of the first photosensitive member 411 and the structure and the operation of the driving coupling 120 coupled with the driven coupling 450 will be representatively described in order to describe the structure and operation of each of the driven couplings 450, 460, 470, and 480 and the corresponding driving couplings 120, 130, 140, and 150.

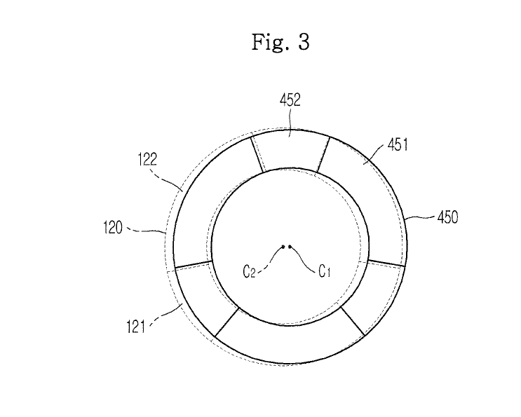

As shown in FIGS. 2 and 3, the driving coupling 120 has a plurality of neighboring driving coupling protrusions 121 arranged at a predetermined angle (e.g., 120°) from each other in relation to a circumference of the driving coupling 120. Furthermore, the driving coupling 120 has a plurality of driving coupling recesses 122 respectively disposed between driving the coupling protrusions 121. It is understood that the driving coupling protrusions 121 need not be arranged at 1200 from each other, and may instead be arranged at a different predetermined angle.

To transmit power to the driven coupling 450 from the driving coupling 120, the driven coupling 450 has driven coupling recesses 452 corresponding to the driving coupling protrusions 121 of the driving coupling 120 and driven coupling protrusions 451 corresponding to the driving coupling recesses 122 of the driving coupling 120. The driven coupling protrusions 451 of the driven coupling 450 are arranged at a predetermined angle (e.g., 120°) from each other in relation to a circumference of the driven coupling 450, and are configured to smoothly connect with the driving coupling 120 in an interlocking fashion. It is understood, however that the driven coupling protrusions 451 need not be arranged at 120° from each other, and instead may be arranged at a different predetermined angle.

When the developing unit 410 is installed in the body 100, the driving coupling protrusion 121 of the driving coupling 120 is inserted between two of the driven coupling recesses 452 of the driven coupling 450, and the driven coupling protrusion 451 of the driven coupling 450 is inserted between the driving coupling recesses 122 of the driving coupling 120, so that the driven coupling 450 is connected with the driving coupling 120 in an interlocking fashion. It is understood that more or less than the three driving coupling protrusions 121, the three driving coupling recesses 122, the three driven coupling protrusions 451, and the three driven coupling recesses 452 may be used to connect the driving coupling 120 with the driven coupling 450.

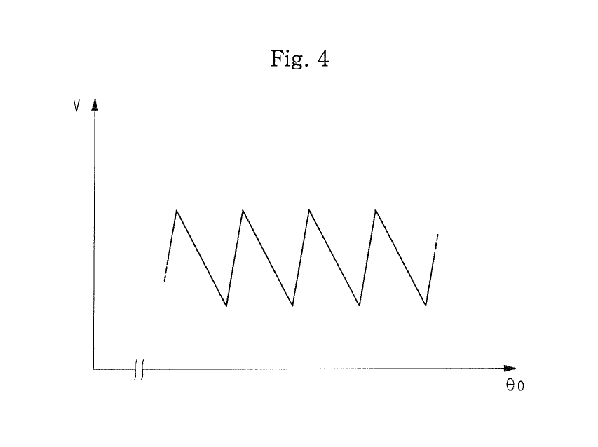

However, when the driven coupling 450 is connected with the driving coupling 120, eccentricity may occur between the central axis C1 of the driven coupling 450 and the central axis C2 of the driving coupling 120, due to manufacturing errors, assembly errors, or some other problem. This eccentricity is shown in an exaggerated fashion in FIG. 3 for illustrative purposes. When eccentricity occurs, the coupling protrusions 451 and 121 of the driven coupling 450 and the driving coupling 120 do not uniformly engage each other due to the deviation between the central axes C1 and C2. Accordingly, when the driving coupling 120 rotates at a constant rotational speed, the rotational speeds of the driven coupling 450 and the photosensitive member 411 connected to the driven coupling 450 periodically change in relation to the constant rotational speed of the driving coupling 120, as shown in FIG. 4.

The rotational speed of the driven coupling 450 changes in proportion to the number of the driven coupling protrusions 451 of the driven coupling 450. For example, according to the embodiment shown in FIG. 2, when the driven coupling 450 has three driven coupling protrusions 451, the variation of the rotational speed of the driven coupling 450 occurs three times with the same waveform during one revolution of the driven coupling 450.

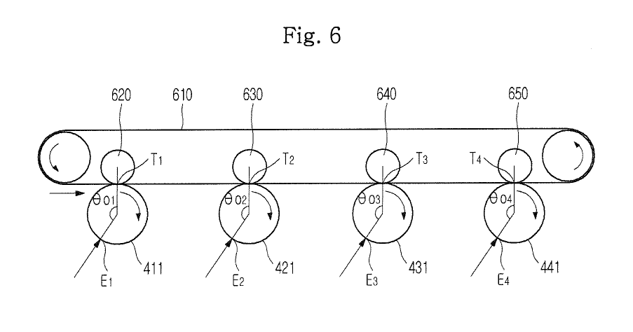

When the rotational speeds of the four photosensitive members 411, 421, 431, and 441 are not uniform, exposure points E1, E2, E3, and E4 (FIG. 6) of the respective photosensitive members 411, 421, 431, and 441, onto which light is incident, move to transfer points T1, T2, T3, and T4 in different time periods. In this case, visible images move to the transfer points T1, T2, T3, and T4 in the different time periods, so that the visible images fail to precisely overlap with each other. As a result, color registration errors occur, and the visible images formed by applying developing agents to electrostatic latent images formed onto the photosensitive members 411, 421, 431, and 441 are not developed properly.

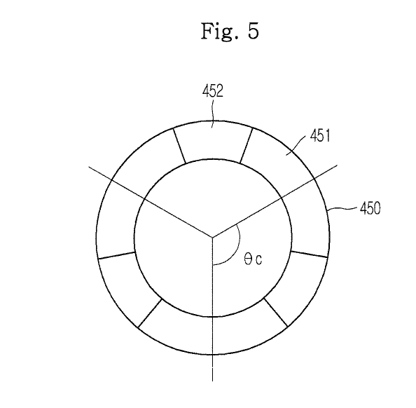

As shown in FIGS. 5 and 6, an aspect of the present invention solves this problem by setting the laser scanning units 510, 520, 530, and 540 such that angles θ₀₁, θ₀₂, θ₀₃, and θ₀₄ formed between the exposure points E1, E2, E3, and E4 and the transfer points T1, T2, T3, and T4 of the photosensitive members 411, 421, 431, and 441 become integer multiples relative to angles θ_{c} between neighboring driven coupling protrusions 451 among the plurality of the driven coupling protrusions 451 of the driven couplings 450, 460, 470, and 480. To this end, after installing the laser scanning units 510, 520, 530, and 540, the number of coupling protrusions 451 of the driven couplings 450, 460, 470, and 480 is determined, and light irradiation positions of the laser scanning units 510, 520, 530, and 540 are determined such that the exposure points E1, E2, E3, and E4 are formed on the surface of the photosensitive members 411, 421, 431, and 441 at specific angles.

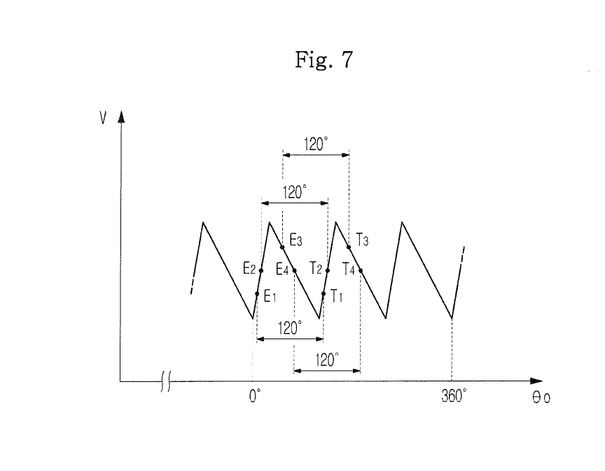

For example, as shown in FIG. 5, if the driven couplings 450, 460, 470, and 480 have three driven coupling protrusions 451, since the angle θ_{c}, between neighboring driven coupling protrusions 451 is 120°, the laser scanning units 510, 520, 530, and 540 are set by determining the light irradiation positions of the laser scanning units 510, 520, 530, and 540 such that angles θ₀₁, θ₀₂, θ₀₃, and θ₀₄ formed between the exposure points E1, E2, E3, and E4 and the respective transfer points T1, T2, T3, and T4 are 120°. In this case, since the photosensitive members 411, 421, 431, and 441 each make one revolution in the same time period, a movement time required to move the exposure points E1, E2, E3, and E4 of the respective photosensitive members 411, 421, 431, and 441 to the transfer points T1, T2, T3, and T4 is equal to ⅓ of the time required for each of the photosensitive members 411, 421, 431, and 441 to make one revolution. In other words, as shown in FIG. 7, the movement time is equal to one period of a waveform showing the variation in rotational speed of the photosensitive members 411, 421, 431, and 441.

For example, as shown in FIG. 7, although the photosensitive members 411, 421, 431, and 441 each have different instantaneous rotational speeds at the respective exposure points E1, E2, E3, and E4, all of the photosensitive members 411, 421, 431, and 441 have the same average rotational speed until the exposure points E1, E2, E3, and E4 of the photosensitive members 411, 421, 431, and 441 rotate by an angle of 120° to the transfer points T1, T2, T3, and T4. In addition, since the visible images formed on the photosensitive members 411, 421, 431, and 441 move to the respective transfer points T1, T2, T3, and T4 in the same time period, the visible images are transferred to a predetermined position on the printing medium, thereby reducing color registration errors.

According to another aspect of the present invention, when the driven couplings 450, 460, 470, and 480 have three driven coupling protrusions 451, such as the example shown in FIG. 2, the laser scanning units 510, 520, 530, and 540 are set such that angles between the exposure points E1, E2, E3, and E4 and the respective transfer points T1, T2, T3, and T4 are at an angle of 240°, which is an integer multiple of the angle θ_{c}, where the integer is 2. In this case, the time required to move the exposure points E1, E2, E3, and E4 of the photosensitive members 411, 421, 431, and 441 to the respective transfer points T1, T2, T3, and T4 is equal to two periods of the waveform shown in FIG. 4.

Similarly, when the number of the driven coupling protrusions 451 of the driven couplings 450, 460, 470, and 480 is two, four, or greater than four, the exposure points E1, E2, E3, and E4 of the photosensitive members 411, 421, 431, and 441 are adjusted such that angles between the exposure points E1, E2, E3, and E4 and the respective transfer points T1, T2, T3, and T4 become integer multiples relative to angles between the driven coupling protrusions 451, thereby reducing color registration errors.

As described above, in the image forming apparatus 10 according to aspects of the present invention, light irradiation positions of the laser scanning units 510, 520, 530, and 540 are set when the laser scanning units 510, 520, 530, and 540 are installed according to a number of driven coupling protrusions, thereby reducing color registration errors in a simple fashion. Furthermore, according to aspects of the present invention, the variation in rotational speeds of the photosensitive members 411, 421, 431, and 441 can be previously detected by using an additional detection unit in such a manner that all visible images formed on the photosensitive members 411, 421, 431, and 441 are moved to the transfer points T1, T2, T3, and T4 in the same time period, thereby reducing a need to install additional components to the image forming apparatus 10 to prevent color registration errors. Moreover, the image forming apparatus according to aspects of the present invention can be employed in various other types of apparatuses, such as, for example, an image forming apparatus using an intermediate transfer belt (ITB) or another type of belt instead of the document transfer belt 610. Also, aspects of the present invention can be applied to any image forming apparatus or other type of device which irradiates a laser beam onto a photosensitive member in order to prevent color registration errors.

As described above, according to aspects of the present invention, light irradiation positions of the laser scanning units 510, 520, 530, and 540 are determined such that the time periods required to move the exposure points of the photosensitive members 411, 421, 431 and 441 to transfer points T1, T2, T3, and T4 are integer multiples relative to the variation period of the rotational speed of the photosensitive members 411, 421, 431 and 441. Therefore, visible images formed on the photosensitive members 411, 421, 431 and 441 are moved to the transfer points T1, T2, T3, and T4 in the same time period. Accordingly, when deviation occurs between a central axis, for example, C1 of the driven coupling 450 of the photosensitive member 411, and another central axis, for example, the central axis C2 of a driving coupling 120 connected to the driven coupling 450, color registration errors are prevented in a simple and effective manner.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. For example, more or less than the three driving coupling protrusions 121, driving coupling recesses 122, driven coupling protrusions 451, and driven coupling recesses 452 may be used in accordance with aspects of the present invention. Accordingly, it is intended, therefore, that the present invention not be limited to the various example embodiments disclosed, but that the present invention includes all embodiments falling within the scope of the appended claims.

1. An image forming apparatus comprising:
a laser scanning unit to irradiate light;
a photosensitive member on which an electrostatic latent image is formed by receiving the light irradiated from the laser scanning unit;
a supply unit to apply a developing agent to the electrostatic latent image formed on the photosensitive member to form a visible image; and
a transfer unit to transfer the visible image formed on the photosensitive member to a printing medium,
wherein a time period in which the photosensitive member is rotated from an exposure point of the photosensitive member at which the light is incident to a transfer point of the photosensitive member at which the visible image is transferred is based on a variation time period of a rotational speed of the photosensitive member.

2. The image forming apparatus as claimed in claim 1, wherein the time period in which the photosensitive member is rotated from the exposure point to the transfer point is equal to the variation time period.

3. The image forming apparatus as claimed in claim 1, wherein the time period in which the photosensitive member is rotated from the exposure point to the transfer point is an integer multiple relative to the variation time period.

4. The image forming apparatus as claimed in claim 1, wherein multiple of the photosensitive members are provided, and time periods in which the multiple photosensitive members are moved from respective exposure points to respective transfer points are integer multiples relative to respective variation time periods.

5. An image forming apparatus comprising:
a laser scanning unit to irradiate light;
a photosensitive member on which an electrostatic latent image is formed by receiving the light irradiated from the laser scanning unit;
a supply unit to apply a developing agent to the electrostatic latent image formed on the photosensitive member to form a visible image;
a transfer unit to transfer the visible image formed on the photosensitive member to a printing medium;
a driven coupling coupled with the photosensitive member and having a plurality of neighboring driven coupling protrusions arranged at a predetermined angle from each other relative to a circumference of the driven coupling; and
a driving coupling engageable with the driven coupling in order to rotate the driven coupling, and having a plurality of driving coupling recesses corresponding to the driven coupling protrusions,
wherein an angle between an exposure point of the photosensitive member at which the light is incident and a transfer point of the photosensitive member at which the visible image is transferred is based on the predetermined angle between the neighboring driven coupling protrusions.

6. The image forming apparatus as claimed in claim 5, wherein the angle between the exposure point and the transfer point is equal to the predetermined angle between the neighboring driven coupling protrusions.

7. The image forming apparatus as claimed in claim 5, wherein the angle between the exposure point and the transfer point is an integer multiple relative to the predetermined angle between the neighboring driven coupling protrusions

8. The image forming apparatus as claimed in claim 5, wherein multiple of the photosensitive members, the driven couplings, and the driving couplings are provided, and angles between exposure points and transfer points of each photosensitive member are integer multiples relative to angles between neighboring coupling protrusions among the protrusions of each driven coupling connected to the respective photosensitive member.

9. An image forming apparatus comprising:
a laser scanning unit to irradiate light;
a photosensitive member on which an electrostatic latent image is formed by receiving the light irradiated from the laser scanning unit;
a supply unit to apply a developing agent to the electrostatic latent image formed on the photosensitive member to form a visible image;
a transfer unit to transfer the visible image formed on the photosensitive member to a printing medium;
a driven coupling coupled with the photosensitive member, and having a plurality of neighboring driven coupling recesses arranged at a predetermined angle from each other relative to a circumference of the driven coupling; and
a driving coupling engageable with the driven coupling in order to rotate the driven coupling and having a plurality of driving coupling protrusions corresponding to the driven coupling recesses,
wherein an angle between an exposure point of the photosensitive member at which the light is incident and a transfer point of the photosensitive member at which the visible image is transferred is based on the predetermined angle of the neighboring driven coupling recesses.

10. The image forming apparatus as claimed in claim 9, wherein the angle between the exposure point and the transfer point is equal to the predetermined angle between the neighboring driven coupling recesses.

11. The image forming apparatus as claimed in claim 9, wherein the angle between the exposure point and the transfer point is an integer multiple relative to the predetermined angle between the neighboring driven coupling recesses.

12. The image forming apparatus as claimed in claim 9, wherein multiple of the photosensitive members, the driven couplings, and the driving couplings are provided, and angles between exposure points and transfer points of each photosensitive members are integer multiples relative to predetermined angles between neighboring coupling recesses among coupling recesses of the driven couplings coupled with the respective photosensitive member.

13. A method to set up a laser scanning unit, the method comprising:
detecting a variation time period of a rotational speed of a photosensitive member on which an electrostatic latent image is formed by irradiated light and a visible image is formed by applying a developing agent to the electrostatic latent image; and
setting a light irradiation position such that a time period in which the photosensitive member is moved from an exposure point of the photosensitive member at which the irradiated light is incident to a transfer point of the photosensitive member at which the visible image is transferred is based on the variation time period.

14. The method as claimed in claim 13, wherein the setting of the light irradiation position comprises setting the time in which the photosensitive member is moved from the exposure point of the photosensitive member to the transfer point of the photosensitive member to be equal to the variation time period.

15. The method as claimed in claim 13, wherein the setting of the light irradiation position comprises setting the time in which the photosensitive member is moved from the exposure point of the photosensitive member to the transfer point of the photosensitive member to be an integer multiple relative to the variation time period.

16. An image forming apparatus comprising:
a photosensitive member to form a visible image when developer is applied to an electrostatic latent image formed by light irradiated to an outer surface thereof;
a transfer unit to transfer the visible image formed on the photosensitive member to a printing medium; and
a driven coupling to rotate the photosensitive member, having a plurality of coupling protrusions arranged at a predetermined angle from each other relative to a circumference of the driven coupling, wherein a rotation of the photosensitive member is adjusted according to a number of the coupling protrusions.

17. The image forming apparatus as claimed in claim 16 wherein:
the photosensitive member has a number of variation time periods based on the number of the coupling protrusions, and
the rotation of the photosensitive member is adjusted so that a time period in which the photosensitive member is rotated from an exposure point of the photosensitive member at which the light is incident to a transfer point of the photosensitive member at which the visible image is transferred is an integer multiple of one of the variation time periods.

18. The image forming apparatus as claimed in claim 17, wherein the time period in which the photosensitive member is rotated from the exposure point to the transfer point is equal to the variation time period.

19. The image forming apparatus as claimed in claim 16, wherein the rotation of the photosensitive member is adjusted so that an angle between an exposure point of the photosensitive member at which the light is incident and a transfer point of the photosensitive member at which the visible image is transferred is an integer multiple relative to the predetermined angle between the coupling protrusions.

20. The image forming apparatus as claimed in claim 19, wherein the angle between the exposure point and the transfer point is equal to the predetermined angle between the coupling protrusions.

21. The image forming apparatus as claimed in claim 16, wherein the number of the coupling protrusions is three.

22. The image forming apparatus as claimed in claim 16, further comprising a driving coupling connected to a motor and engageable with the driven coupling in order to rotate the driven coupling by transmitting power from the motor, wherein the driving coupling has a plurality of coupling recesses corresponding to the coupling protrusions to interlock with the driven coupling.

23. The image forming apparatus as claimed in claim 16, wherein multiple of the photosensitive member and the driven coupling are provided to correspond to cyan, magenta, yellow, and black colors.

24-34. (canceled)
